(19) United States
(12) Patent Application Publication
(10) Pub. No.: US 2026/0249762 A1
(43) Pub. Date: Aug. 27, 2026

(54) CUSHION LATCH FOR VEHICLE SEAT

(71) Applicant: Brose Fahrzeugteile SE & Co. Kommanditgesellschaft, Coburg, Coburg (DE)

(72) Inventor: Jeremy MOSELEY, Warren, MI (US)

(73) Assignee: Brose Fahrzeugteile SE & Co. Kommanditgesellschaft, Coburg, Coburg (DE)

(21) Appl. No.: 19/062,541

(22) Filed: Feb. 25, 2025

(51) Int. Cl. B60N 2/90; B60N 2/30

(52) U.S. Cl. CPC B60N 2/933; B60N 2/3047; B60N 2002/967

(57) ABSTRACT

A latch for use in a vehicle seat configured to selectively lock and unlock a cushion of the vehicle seat, the cushion configured to be disposed in a use position and non-use position, and the latch including a catch, a primary pawl, and a secondary pawl. The catch fixed to the cushion and rotatable about a first axis. The primary pawl configured to rotate about a second axis, different than the first axis between a locked position, in which the primary pawl engages and fixes the catch in the use position and the non-use position. The secondary pawl configured to rotate about a third axis between an engaged position, in which the secondary pawl and the catch sandwich the primary pawl, and a disengaged position to permit disengagement of the primary pawl from the catch.

### TECHNICAL FIELD

The present disclosure relates to vehicle seats, in particular vehicle seats configured to change between a use position and a stowed position.

### BACKGROUND

Automotive vehicles include seat assemblies that may include a seat back and a seat cushion collectively configured to support a vehicle occupant. In some vehicles, such as truck or lorry, one or more of portions of the seat assemblies (e.g., a cushion) may be configured to move from a use position (e.g., seated position) to a non-use position (e.g., a stowed position). Those vehicle seats may include one or more latches configured to selectively lock the cushion in the use position and the non-use position.

### SUMMARY

An aspect of the present disclosure includes a vehicle seat. The vehicle seat may include a cushion, configured to rotate between use position and a non-use position, and a latch configured to selectively lock and unlock the cushion disposed in the use position or the non-use position. The latch including a catch, a primary pawl, and a secondary pawl. The catch may be fixed (e.g., directly or indirectly) to the cushion and may be configured to rotate with the cushion between the use position and the non-use position. The primary pawl may be configured to move between a locked position, in which the primary pawl engages and fixes the catch in either the use position or the non-use position, and an unlocked position, in which the primary pawl permits rotation of the catch between the use position and the non-use position. The secondary pawl may be configured to selectively move from a disengaged state to an engaged state so that the secondary pawl permits movement of the primary pawl from the unlocked position to the locked position.

The vehicle seat may also include a cable and the latch may include a transmission assembly. The cable may be configured to be connected to an activation member. The transmission assembly may be operatively coupled to the secondary pawl and configured to transmit a force applied by a user to the activation member, to the secondary pawl in order to move the secondary pawl from the engaged state to the disengaged state.

The secondary pawl may include a main body and a first arm extending therefrom. A distal end of the first arm may define a cam profile configured to engage a cam follower defined by the primary pawl as the secondary pawl moves from the disengaged state to the engaged state.

The vehicle seat may include an activation member disposed on the vehicle seat and configured to be grasped and actuated by a user. The secondary pawl may include a second arm extending from the main body and operatively connected to the activation member such that actuation of the activation member by a user moves the secondary pawl from the engaged state to the disengaged state to permit rotation of the catch between the use position and the non-use position.

In one or more embodiments, the catch may define a first detent and a second detent, the primary pawl may include a main body and a primary arm extending therefrom. A first side of the primary arm includes a locking wedge configured to be received by the first detent when the catch is in the use position and configured to be received by the second detent when the catch is in the non-use position.

The primary arm includes a second side opposing the first side, the second side defining a cam follower configured to be engaged by a cam profile defined by the secondary pawl.

According to another aspect of the present disclosure, a latch configured to selectively lock and unlock a cushion of a vehicle seat disposed in a use position and a non-use position is provided. The latch includes a catch, a primary pawl, and a secondary pawl. The catch may be configured to be fixed to the cushion of the vehicle seat and rotate about a first axis between the use position and the non-use position. The primary pawl may be configured to rotate about a second axis, different than the first axis, between a locked position, in which the primary pawl engages and fixes the catch in the use position and the non-use position. The secondary pawl may be configured to rotate about a third axis, different than the second axis, between an engaged position, in which the secondary pawl and the catch sandwich the primary pawl, and a disengaged position to permit disengagement of the primary pawl from the catch.

According to another aspect of the present disclosure, a latch configured to selectively lock and unlock a cushion of a vehicle seat disposed in a use position and a non-use position. The latch includes a housing, a catch, a primary pawl, a secondary pawl, and an activation lever. The housing includes a first sidewall and a peripheral edge portion, the first sidewall defining a cushion fixation aperture, and the peripheral edge portion defining an opening. The catch may be configured to be fixed to the cushion of the vehicle seat and rotationally connected to the first sidewall of the housing, and the catch may be configured to rotate about a first axis with the cushion between the use position and the non-use position. The primary pawl may be rotationally connected to the first sidewall of the housing and configured to rotate about a second axis, different than the first axis, between a locked position, in which the primary pawl engages and fixes the catch in the use position and the non-use position, and an unlocked position in which the primary pawl is spaced apart from the catch. The secondary pawl may be rotationally connected to the first sidewall of the housing and configured to rotate about a third axis, different than the second axis, between an engaged position, in which the secondary pawl and the catch sandwich the primary pawl, and a disengaged position to permit disengagement of the primary pawl from the catch. The activation lever may be rotationally connected to the first sidewall of the housing and configured to rotate about a fourth axis. The activation lever may include a main body, a first arm, and a second arm. The first and second arms may extend from the main body. The first arm may be operatively coupled to the secondary pawl, and the second arm may extend through the opening defined by the peripheral edge portion. As a force is applied to the second arm, the activation lever rotates about the fourth axis to permit rotation of the secondary pawl from the engaged position to the disengaged position.

### BRIEF DESCRIPTION OF THE DRAWINGS

FIG. 1 is a schematic diagram of an exemplary vehicle seat according to one or more embodiments.

FIGS. 2A-2B are perspective views of a latch for use in the vehicle seat.

FIG. 3 is a partial-perspective view of the latch according to one or more embodiments.

FIG. 4 is a schematic diagram of another exemplary vehicle seat according to one or more embodiments.

FIG. 5A is a plan view of another latch in a locked state in which the catch is disposed in the use position.

FIG. 5B is a plan view of the latch shown in FIG. 5A in an unlocked state in which the catch is disposed in the use position.

FIG. 5C is a plan view of the latch shown in FIG. 5A in the locked state in which the catch is disposed in the non-use position.

FIG. 6 is a perspective view of an exemplary vehicle seat provided with the latch shown in FIGS. 5A-5C.

FIGS. 6A & 6B are detail perspective views taken along the lines 6-6 in FIG. 6.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

As used in the specification and the appended claims, the singular form “a,” “an,” and “the” comprise plural referents unless the context clearly indicates otherwise. For example, reference to a component in the singular is intended to comprise a plurality of components.

The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within ±0%, 0.1%, 0.5%, 1%, 2%, 3%, 4%, 5% or 10% of the value or relative characteristic.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As stated above, certain vehicle seat assemblies include a seat cushion that may be moved between a use position (e.g., seated position), in which the cushion is positioned to support an occupant, and a non-use position (e.g., stowed position) in which the cushion is positioned to provide additional space for ingress, egress, items to be stowed, or some combination thereof. Generally, the cushion must be locked or fixed when in the stowed position to avoid in advertent movement of the cushion from the stowed position. Under certain circumstances, such as when the force or effort required to raise the cushion from the use position to the stowed position is above a predetermined threshold due to the weight and/or kinematic arrangement of the cushion, a spring may be employed to bias the cushion towards the non-use or stowed position, thus reducing the force or effort required to move the cushion. Under such circumstances, the cushion must be fixed or locked within the use position, otherwise, a constant force or effort would be required to maintain the position of the cushion in the use position.

Latches are known to secure portions of vehicle seats within the stowed position. Known latches are generally costly, relatively heavy, and complex to manufacture. Moreover, known latches only fix the position of the vehicle seat component in the stowed position.

The present disclosure attempts to address these problems.

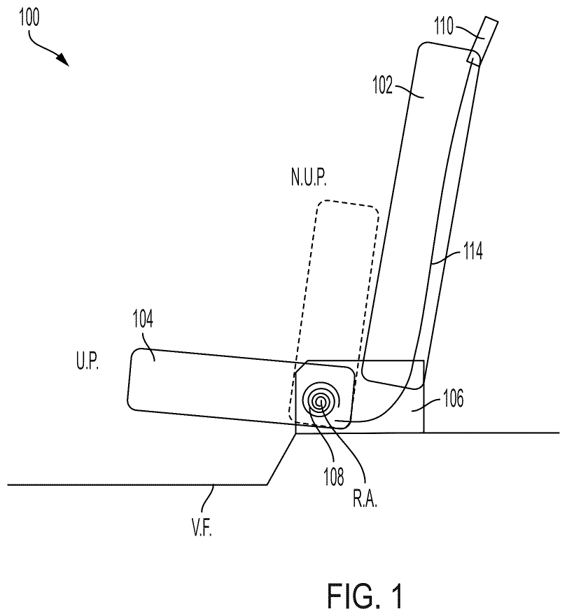

FIG. 1 shows a schematic representation of an exemplary vehicle seat 100 provided with a backrest 102, a cushion 104, and a latch assembly (generally referred to herein as “latch 106”) according to one or more embodiments. The seat 100 may be a second row seat for use in one or more vehicles (e.g., pickup truck), though the present disclosure contemplates other seats (e.g., first row, third row) for other types of vehicles (e.g., coupes, sedans, SUVs). The vehicle seat 100 may be disposed on a vehicle floor V.F. and the cushion 104 is configured to rotate about a first rotational axis A1 between a use position U.P. (e.g., seated or design position) and a non-use position N.U.P. (e.g., stowed position). In one or more embodiments, the seat 100 may include one or more cushion lift springs 108 configured to bias the cushion 104 from the use position U.P. to the non-use position N.U.P.

The vehicle seat 100 may also include an activation member 110 (e.g., release strap) and a transmission assembly 112 extending between the activation member 110 and the latch 106. To move the cushion 104 from the use position U.P. to the non-use position N.P., a user may apply a force to an activation member 110 disposed on the vehicle seat 100 and a transmission assembly 112 may transmit the force applied to the activation member 110 to the latch 106 so that the latch is unlocked to permit rotation of the cushion 104 from the use position U.P. to the non-use position N.U.P. In one or more embodiments, the transmission assembly 112 may include a Bowden cable 114 extending between the activation member 110 and the latch 106.

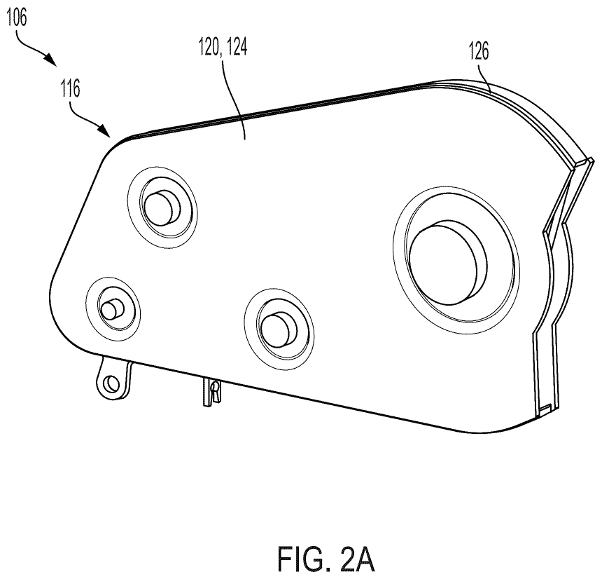

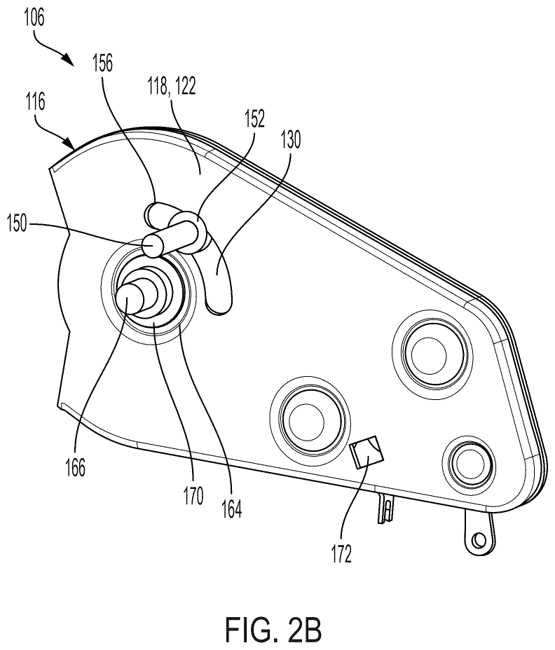

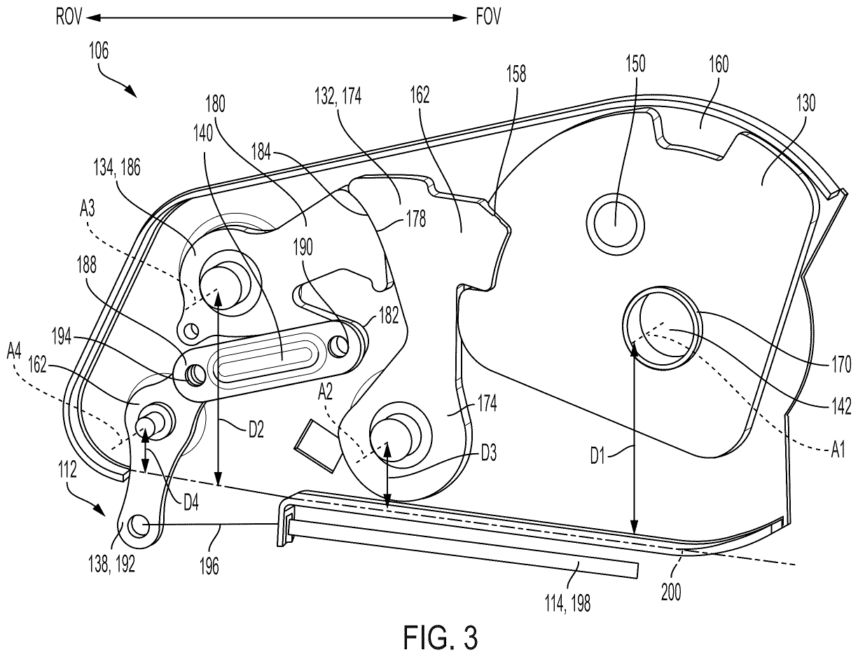

FIG. 2A shows an outboard perspective view of the latch 106 and FIG. 2B shows an inboard perspective view of the latch 106. FIG. 3 shows the latch 106 without a portion of the housing 116 so that the internal components of the latch 106 may be viewed. The latch 106 and specifically the catch 130 is shown in a position in which the cushion 104 is in the use position. As described herein, the latch 106 has a relatively lightweight and compact design. Internal components of the latch 106 may be disposed within a housing 116 configured to substantially enclose the internal components of the latch 106 to prevent debris (e.g., dirt, food) or a user's appendage from interfering with the internal components of the latch 106. The housing 116 may be formed by a first housing shell 118 and a second housing shell 120 that may be fixed to the first housing shell 118. The first housing shell 118 includes a first sidewall 122 and the second housing shell 120 includes a second sidewall 124 that opposes the first sidewall 122. For purposes of clarity and orientation, a bi-directional arrow is shown in FIG. 3 to identify a front of the vehicle (FOV) and a rear of the vehicle (ROV).

Within the housing 116, the latch 106 includes a catch 130, a primary pawl 132, a secondary pawl 134, and a latch transmission assembly 136. The latch transmission assembly 136 may include an activation lever 138 and a force transmission member (e.g., link arm 140). In one or more embodiments, the latch transmission assembly 136 may form a portion of the transmission assembly 112 described above. One or more of internal components of the latch may be rotationally connected to the first sidewall 122 of the first housing shell 118. The catch 130 may define one or more recessed portions such as a first locking detent 158 and a second locking detent 160, and as will be described in greater detail below, the first and second locking detents 158, 160 are each configured to receive a locking wedge 162 formed by the primary pawl 132 to fix the catch 130 in one or more positions.

The first sidewall 122 of the first housing may define an aperture 164 defining the first rotational axis A1 about which the cam 136 rotates. As an example, the aperture 164 may be disposed within a first recessed area 168 defined by the first sidewall 122. The cam 136 may be rotationally coupled to the first sidewall 122 by a bushing 170 that may be disposed within (e.g., fixed to) the aperture 164.

One or more portions of the latch 106 to the cushion 104 may be fixed to (e.g., directly or indirectly) to the cushion 104 to provide a robust connection between the latch 106 and the cushion 104. As an example, a first seat fastener 166 may extend through the bushing 170 and thread into one or more portions of the seat 100, such as the cushion 104 or another structural member (e.g., a transverse tube or a bracket fixed to the cushion 104 so that the catch is fixed to the cushion 104 about the first rotational axis A1). The first recessed area 168 may enable the seat fastener 166 to be seated within a side profile of the first and second sidewalls 122, 124 to provide a relatively compact design.

The first sidewall 122 may define a slot 156 that is spaced apart from the rotational axis A1 and a pin 150 may extend from the catch 130 through the slot 156 and terminate at the cushion 104. As an example, the pin 150 may be a threaded fastener configured to receive a nut (not illustrated) configured to fix the cushion 104 to the catch 130. The pin 150 may be fixed directly to the cushion 104, however, the pin 150 may also be attached to an intermediate bracket or another structural member fixed to the cushion 104. The pin 150 may include a flange 152 which may move along a peripheral portion of the slot 156. The flange 152 may also form a portion of the threaded joint formed between the cushion 104 and the catch 130 so that the cushion 104 or another structural member fixed thereto abuts against the flange 152. Alternatively or additionally, the first sidewall 122 may define one or more apertures such as a cushion fixation aperture 172 that may be configured to receive a fastener (not illustrated) to provide another fixation point between the cushion 104 and the latch 106.

As stated above, the catch 130 of the latch 106 shown in FIG. 3 is positioned such that the cushion 104 is disposed in the use position, in which the first locking detent 158 receives the locking wedge 162 of the primary pawl 132. The primary pawl 132 includes a main body 174 and a primary arm 176, the main body 174 may be rotationally coupled to the first sidewall 122 about a second rotational axis A2 and the primary arm 176 may extend from the main body 174. One side of the primary arm 176 may define a cam follower 178 and a second side of the primary arm 176 may form the locking wedge 162, the locking wedge 162 may be positioned opposite from at least a portion cam follower 178.

The secondary pawl may include a main portion 186, a first arm 180, and a second arm 182, the first and second arms 180, 182 each extending from the main portion 186. The main portion 186 may be rotationally coupled or connected to the first sidewall 122 and configured to rotate about a third rotational axis A3. The first arm 180 of the secondary pawl 134 includes a cam 184 configured to engage the cam follower 178 as the secondary pawl 134 rotates in order to move the primary pawl 132 into engagement with the catch 130. The activation lever 138 may be rotationally connected to the first sidewall about a fourth rotational axis A4 and includes a first arm 192 and a second arm 194.

The second arm 194 of the activation lever 138 may be coupled to the secondary pawl 134 by a link arm 140, and a cable or wire 196 may be fixed to the first arm 192 of the activation lever 138. The wire 196 or portions of the wire 196 may be disposed within a cable sheath 198, and as a force is applied to the activation member 110 (FIG. 1) the wire 196 may move with respect to the cable sheath 198 to pull the first arm 192 and rotate the activation lever 138 (e.g., in a counter-clockwise direction). Rotation of the activation lever 138 causes the link arm to move and the secondary pawl 134 to rotate so that the cam 184 no longer sandwiches the primary pawl 132 to the catch 130. The primary pawl may be biased by a spring (not illustrated) so that once the secondary pawl 134 disengages from the primary pawl 132, the primary pawl disengages from the catch 130, thus allowing the catch 130 to rotate (e.g., in the counter-clockwise direction) from the use position to the non-use position. In one or more embodiments, the second arm 182 of the secondary pawl 134 may be rotationally connected to the second end 190 of the link arm 140 and the second arm 194 of the activation lever 138 may be rotationally connected to the first end 188 of the link arm 140.

The first, second, third, and fourth rotational axes A1-A4 may be spaced apart from a peripheral edge portion 200 of the first sidewall 122. As an example, the first rotational axis A1 may be spaced apart from the peripheral edge portion 200 by a first distance D1, the third rotational axis may be spaced apart from the peripheral edge portion 200 by a second distance D2, the second rotational axis A2 may be spaced apart from the peripheral edge portion 200 by a third distance D3, and the fourth rotational axis A4 may be spaced apart from the peripheral edge portion 200 by a fourth distance D4. As an example, the first distance D1 may be greater than the second distance D2, the second distance D2 may be greater than the third distance D3, and the third distance D3 may be greater than the fourth distance D4. The distances D1-D4 for the respective rotational axes A1-A4 may be arranged so that with respect to the peripheral edge portion 200, so that the third rotational axis A3 is disposed between the first rotational axis A1 and the second rotational axis A2, and the fourth rotational axis A4 may be disposed nearest to the peripheral edge portion 200 relative to the other rotational axes A1-A3.

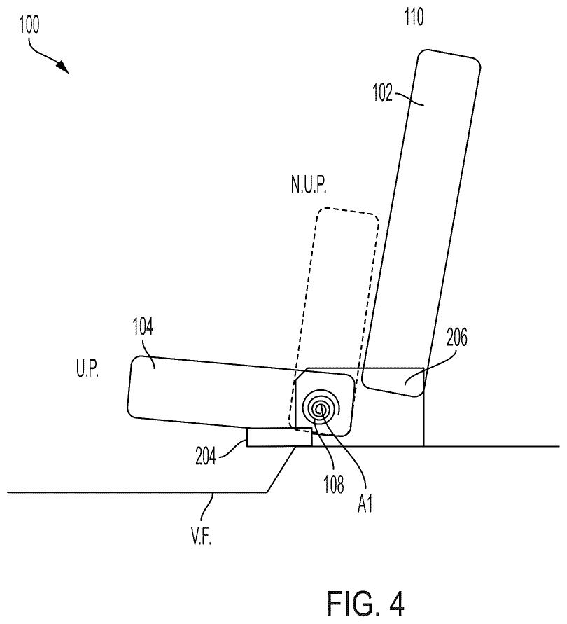

FIG. 4 shows a schematic diagram of another exemplary vehicle seat 202 according to one or more embodiments. The vehicle seat 202 may include components that are common to the vehicle seat 100 and those components are identified with common reference numbers and the description of those common components will not be duplicated. The seat 202 may include another latch assembly or latch 206 and an activation member 204 that may be operatively coupled to the latch 206. As will be described herein, the activation member 204 may be formed by a lever and may enable the elimination of the Bowden cable 114 (FIG. 1).

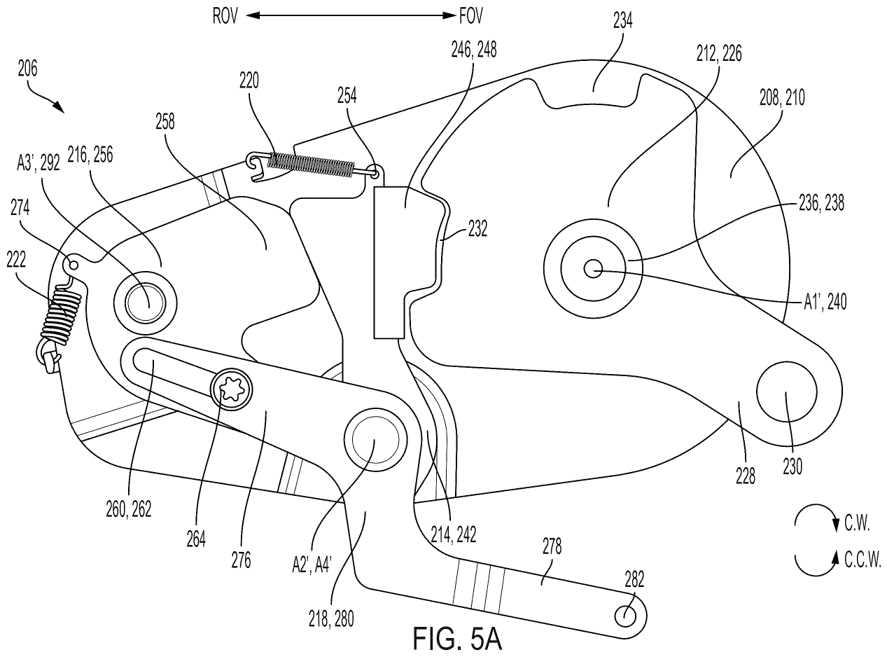

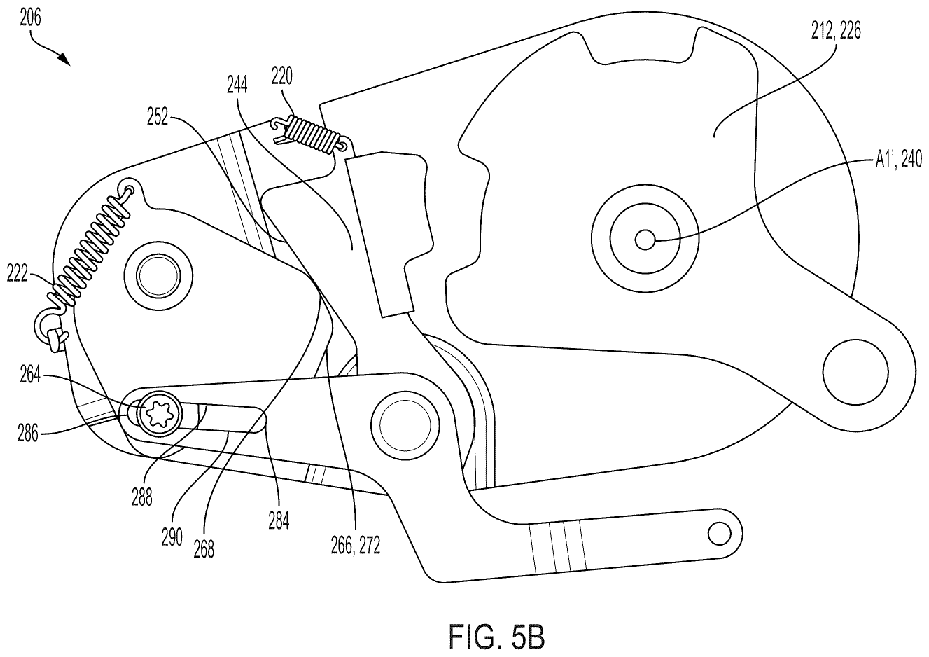

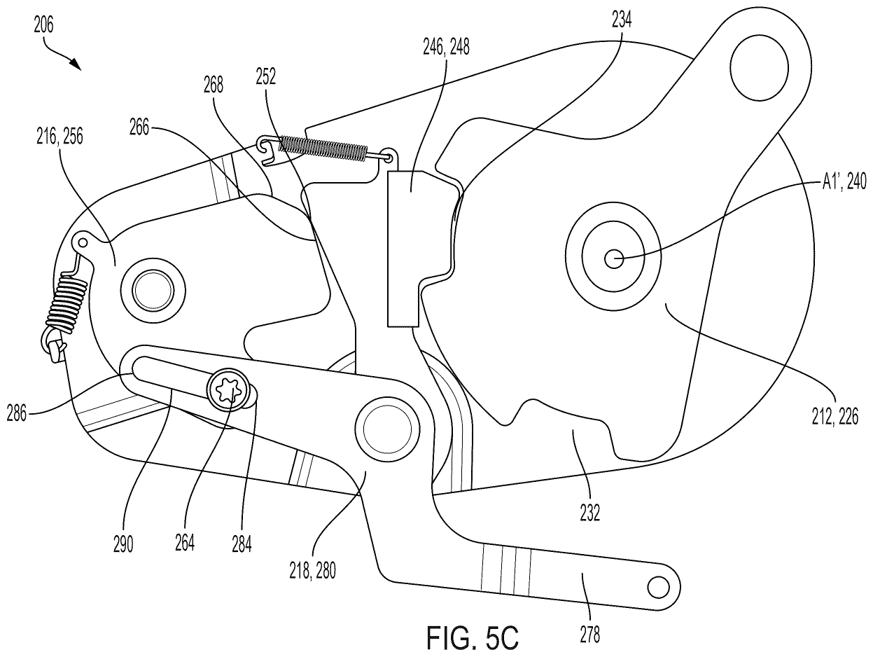

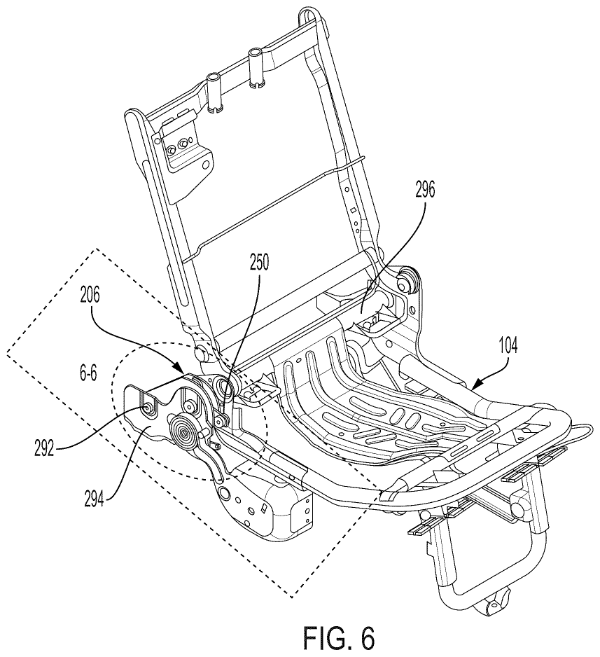

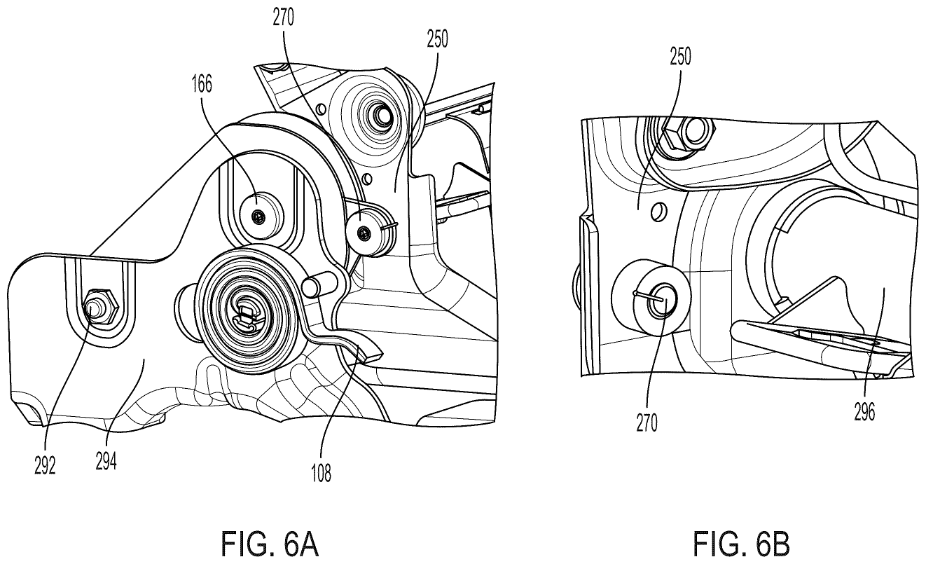

FIGS. 5A-5C show partial-plan views of the latch 206 in a locked condition in which the cushion 104 is in the use position, an unlocked condition, and another locked in which the cushion is in the non-use position. For purposes of clarity and orientation, a bi-directional arrow is shown in FIG. 3 to identify a front of the vehicle (FOV) and a rear of the vehicle (ROV). FIG. 6 shows a perspective view of the vehicle seat 202 and FIG. 6A and FIG. 6B show detail perspective views taken along lines 6-6 in FIG. 6. The latch 206 includes a catch 212, a primary pawl 214, a secondary pawl 216, and the activation lever 218 one or more of which may be rotationally connected a first sidewall 210 of a housing 208 of the latch 206.

The catch 212 may include a main body 226 rotationally connected to the first sidewall 210 of the housing 208 and fixed to one or more portions of the cushion 104, such as a cushion attachment bracket 250, so that as the catch 212 rotates about a first rotational axis A1′ from a first position (FIG. 5A), in which the cushion 104 is in the use position UP, to a second position (FIG. 5C) cushion 104 rotates to the non-use position N.P. (FIG. 4). As an example, when the cushion 104 moves from the use position UP to the non-use position N.U.P., the catch 212 may rotate in a first rotational direction (e.g., counter-clockwise (C.C.W.) as represented by the directional arrow C.C.W.) and as the cushion 104 moves from the non-use position N.U.P. to the use position, the catch 212 may rotate in a second rotational direction (e.g., clockwise (C.W.) as represented by the directional arrow C.W.).

The catch 212 may include a main body 226 and an arm 228 that may extend therefrom, the main body 226 and the arm 228 may be configured for attachment to the cushion 104 at one or more points so that the cushion 104 rotates with the catch 212. As an example, the main body 226 of the catch 212 may define a catch aperture 240 configured to receive the cushion attachment fastener 166 which may engage (e.g., thread into) the cushion 104 or another support structure of the vehicle seat 202 fixed to the cushion 104. A bushing 236 may be disposed within the catch opening 240 to fix the catch 212 to the housing 208 and permit rotation of the same about the first axis A1′. The bushing 236 may include a lateral sidewall 238 that may be deformed (e.g., upset, bent over) to secure the catch 212 to the housing 208. As another example, a distal portion of the arm 228 may define another aperture 230 configured to receive a fastener 270 for attachment to the cushion 104 or another support structure of the vehicle seat 202 fixed to the cushion 104. While apertures 230, 240 are shown, it should be appreciated that other types of fasteners (e.g., threaded stud, nut) are contemplated herein.

The primary pawl 214 includes a main portion 242 and a primary arm 244 extending therefrom. The main portion 242 may be rotationally connected to the first sidewall 210 to enable rotation of the primary pawl 214 about a second pivot axis A2′ in an opening direction (C.C.W.), in which the primary arm 244 moves away from the catch 212, and in a closing direction (C.W.) in which the primary arm 244 moves towards the catch 212. A distal end of the primary arm 244 may include a spring retention feature 254 configured for attachment to a primary spring 220 and the primary arm may taper from the distal end towards the main portion 242. One end of the primary spring 220 may be fixed to the housing 208, such as an edge portion of the housing disposed rearward of the catch 212, and the other end of the primary spring 220 may be fixed to the spring retention feature 254, so that the primary spring 220 biases the distal end of the primary pawl 214 away from the catch 212.

A first side of the primary arm 244 may define a cam follower 252 and a second side of the primary arm 244 may define a locking wedge 246 that may oppose at least a portion of the cam follower 252. The locking wedge 246 may be tapered and configured to be inserted into the first locking detent 232 and the second locking detent 234. In one or more embodiments, a locking wedge cap 248 may be disposed on the locking wedge 246. The locking wedge cap 248 may be formed of a polymeric material configured to prevent or mitigate noise (e.g., buzz, squeak, rattle) during vehicle operation.

In one or more embodiments, the locking wedge cap 248 may be formed of an elastomeric material or another suitable material configured to deform (e.g. compress) as a force is applied to the locking wedge cap 248 and return to its original shape after being deformed. This ability of the locking wedge cap 248 to deform and return to its original shape may enable a force fit or press fit condition between the primary pawl 214 and the catch 212, and the force fit or press fit condition between the primary pawl 214 and the catch 212 may eliminate or at least reduce free play (e.g., chuck) between the catch 212 and the primary pawl 214. Moreover, the reduced free play may be multi-directional, meaning free play may be reduced in both the forward or rearward direction and cross-car directions.

The secondary pawl 216 may include a main portion 256, a first arm 258, and a second arm 260, the first and second arms 258, 260 may each extend from the main portion 256. The secondary pawl 216 may be rotationally connected to the housing 208 (e.g., sidewall 210) and configured to rotate about a third rotational axis A3′. In one or more embodiments, the third rotational axis A3′ may be defined by a seat attachment fastener 292 that may extend through a support structure (e.g., an outboard seat bracket 294 shown in FIG. 6 and FIG. 6A), the secondary pawl 216, and a portion of the housing 208 (e.g., first sidewall 210). A distal end of the first arm 258 may define a cam 266 configured to engage the cam follower 252 of the primary pawl 214 as the latch 206 changes from the unlocked state to the locked state. The cam 266 may have a curved profile 272 so that as the secondary pawl rotates about the third rotational axis A3′ in the second rotational direction (C.C.W.), the primary pawl 214 rotates towards the catch 212. The distal end of the secondary pawl 216 may also include a straight-edge portion 268 extending form the cam 266 to enable disengagement of the secondary pawl 216 from the primary pawl 214 as the latch 206 changes from the locked state to the unlocked state. As an example, the cam 266, the straight edge portion 268, or both may be completely disengaged from the primary pawl 214 when the latch 206 is in the unlocked state. However, in other embodiments, it is readily contemplated that the straight edge portion 268, the cam 266, or both may contact one or more portions of the primary pawl 214 (e.g., the cam follower 252).

In one or more embodiments, the secondary pawl 216 may be biased towards the engaged position, in which the secondary pawl 216 engages the primary pawl 214. As an example, a secondary spring 222 provided with a first end, fixed to a secondary spring retention feature 274, and a second end fixed to a portion of the housing 208 (e.g., sidewall 210) may bias portions of the secondary pawl 216 (e.g., cam 266) towards the primary pawl 214. While primary spring 220 and the secondary spring 222 are shown as compression springs, the present disclosure contemplates other types of springs (e.g., torsion spring), however, the use of compression springs as the primary and secondary springs 220, 222 may enable a more compact design, specifically in the cross-car direction, as the use of a torsion spring would require additional space to accommodate the coils between each spring leg.

The latch 206 may include an activation lever 218 provided with a main portion 280, a first arm 276, and a second arm 278, the first and second arms 276, 278 may extend from the main portion 280 in opposite directions. The activation lever may be rotationally connected to the housing 208 (e.g., the first sidewall 210) and configured to rotate about a fourth rotational axis A4′. In one or more embodiments, the second rotational axis A2′ may be the same as the fourth rotational axis A4′. The first arm 276 of the activation lever 218 may define an opening such as a slot 262 and a coupling member 264 disposed on or formed as a portion of the second arm 260 of the secondary pawl 216 may be disposed within the slot 262 to operatively couple the activation lever 218 to the secondary pawl 216.

The second arm 278 of the activation lever 218 may extend beyond an edge of the housing 208 to enable access to the activation lever 218. A distal end portion of the second arm 278 may define an activation member aperture 282 configured for attachment to the activation member 204 (FIG. 4). As a user applies a force to the second arm 278, when the latch 206 is in the locked condition, the activation lever 218 may rotate in the second rotational direction (C.C.W.) and a first edge 288 of the slot 262 may apply a force to the coupling member 264 so that the secondary pawl 216 rotates in the first rotational direction (C.W.) to move the cam 266 away from the cam follower 252. As the activation lever 218 rotates, the coupling member 264 may move from a first end 284 of the slot towards a second end 286 of the slot 262. Once the secondary pawl 216 no longer sandwiches the primary pawl 214 to the catch 212, the primary pawl 214 may rotate in the second rotational direction (e.g., by a force applied by the primary spring 220) and disengage from the catch 212. The catch 212 may then rotate with the cushion 104 from the use position (FIG. 5A and FIG. 5B) to the use non-use position (FIG. 5C). Note, in one or more embodiments, the activation lever 218, the coupling member 264, and the second arm 260 of the secondary pawl 216 may be referred to as a transmission assembly 300 configured to transmit force applied to the second arm 278 of the activation lever 218 to the cam 266 of the secondary pawl 216 and the cam follower of primary pawl 214.

Upon the cushion 104 along with the catch 212 being moved to the non-use position (FIG. 5C), a return force applied to one or more portions of the activation lever 218 (e.g., the second arm 278) causes the latch 206 to change from the unlocked state (FIG. 5B) to the locked state (FIG. 5C). As an example, the return force may be applied by a user to the second arm 278, or one or more return springs (not illustrated) may be provided to actuate the activation lever 218 in order to change the latch 206 form the unlocked state to the locked state. The return force may rotate the activation lever 218 in the first rotational direction (C.W.) so that the second edge 290 of the slot 262 applies a force to the coupling member 264, to move the coupling member 264 away from the second end 286 of the slot 262 towards the first end 284 of the slot 262 in order to rotate the secondary pawl 216 in the second rotational direction (C.C.W.). As the secondary pawl 216 rotates from the disengaged position (FIG. 5B), the straight edge portion 268 may move past (e.g., without contacting) the cam follower 252, and the cam 266 may engage the cam follower 252 so that the primary pawl 214 rotates in the first rotational direction (C.W.). Rotating the primary pawl 214 from the disengaged position (FIG. 5B) to the engaged position causes the locking wedge cap 248 disposed on the locking wedge 246 to be inserted into the second locking detent 234 defined by the cam 266.

As stated above, the latch 206 may be fixed to the cushion 104 at one or more fixation points and fixed to one or more portions of the vehicle seat 202. The vehicle seat 202 includes the cushion 104, a cushion attachment bracket 250, and a seat support structure that may include an outer seat bracket 294 and a transverse tube 296. As one example, the first cushion attachment fastener 166 may extend through the outer seat bracket 294, the catch 212, and the cushion attachment bracket 250. Alternatively or additionally, the first cushion attachment fastener 166 may thread into the transverse tube 296 that abuts against the cushion attachment bracket 250. The seat attachment fastener 292 may extend through the outer seat bracket 294 and through the secondary pawl 214 to fix the latch 206 to the seat support structure. The cushion attachment fastener 270 may extend through the cushion attachment aperture 230 defined by the catch 212 and into threaded engagement with a weld nut 298 disposed on the cushion attachment bracket 250.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### PARTS LIST

100 vehicle seat
102 backrest
104 cushion
106 latch
108 cushion lift spring
110 activation member
112 transmission assembly
114 Bowden cable
116 housing
118 first housing shell
120 second housing shell
122 first sidewall
124 second sidewall
126 housing lip
128 peripheral edge portion
130 catch
132 primary pawl
134 secondary pawl
136 latch transmission assembly
138 activation lever
140 force transmission member, link arm
142 catch aperture
146 bushing
148 fastener cushion
150 pin
152 flange
156 slot
158 first locking detent
160 second locking detent
162 locking wedge
164 aperture
166 cushion fastener
168 first recessed area
170 bushing
172 cushion fixation aperture
174 main body
176 primary arm
178 cam follower
180 first arm secondary pawl
182 second arm secondary pawl
184 cam
186 main portion
188 first end link arm
190 second end link arm
192 activation lever first arm
194 activation lever second arm
196 wire
198 cable sheath
200 peripheral edge housing
202 vehicle seat
204 activation member
206 latch
208 housing
210 first sidewall
212 catch
214 primary pawl
216 secondary pawl
218 activation lever
220 primary spring
222 secondary spring
224 coupling member
226 main body of catch
228 arm of catch
230 cushion attachment aperture catch
232 first locking detent
234 second locking detent
236 bushing
238 lateral wall bushing
240 catch aperture
242 main portion primary pawl
244 primary arm
246 locking wedge
248 locking wedge cap
250 bracket
252 cam follower
254 spring retention feature, primary pawl
256 main portion secondary pawl
258 first arm secondary pawl
260 second arm secondary pawl
262 slot
264 coupling member
266 cam
268 straight edge portion
270 cushion attach fastener
272 curved profile
274 secondary spring retention feature
276 first arm activation lever
278 second arm activation lever
280 main portion
282 activation member aperture
284 first end slot
286 second end slot
288 first edge slot
290 second edge slot
292 seat attachment fastener
294 outer seat bracket
296 transverse tube
298 weld nut

What is claimed is:

1. A vehicle seat comprising:
a cushion configured to rotate between a use position and a non-use position; and
a latch configured to selectively lock and unlock the cushion disposed in the use position or the non-use position, the latch including:
a catch fixed to the cushion and configured to rotate with the cushion between the use position and the non-use position,
a primary pawl configured to move between a locked position, in which the primary pawl engages and fixes the catch in either the use position or the non-use position, and an unlocked position, in which the primary pawl permits rotation of the catch between the use position and the non-use position, and
a secondary pawl configured to selectively to move from a disengaged state to an engaged state so that the secondary pawl moves the primary pawl from the unlocked position to the locked position.

2. The vehicle seat of claim 1, wherein the secondary pawl includes a main body and a first arm extending therefrom, wherein a distal end of the first arm defines a cam profile configured to engage a cam follower, defined by the primary pawl, as the secondary pawl moves from the disengaged state to the engaged state.

3. The vehicle seat of claim 2, further comprising:
an activation member disposed on the vehicle seat and configured to be grasped and actuated by a user, wherein the secondary pawl includes a second arm extending from the main body and operatively connected to the activation member such that actuation of the activation member by a user moves the secondary pawl from the engaged state to the disengaged state to permit rotation of the catch between the non-use position and the use position.

4. The vehicle seat of claim 3, wherein the activation member includes a medial portion, a first arm, and a second arm, the first and second arms extending from the medial portion, the second arm coupled to the secondary pawl, wherein the activation member is configured to rotate about the medial portion in response to the user applying a force to the first arm so that the second arm rotates the secondary pawl between the disengaged state and the engaged state.

5. The vehicle seat of claim 4, further comprising:
a coupling member fixed to the second arm of the secondary pawl, wherein the second arm of the activation member defines an elongated slot provided with a first end and a second end, wherein as the secondary pawl moves between the disengaged state and the engaged state, the coupling member moves from the first end of the slot to the second end of the slot.

6. The vehicle seat of claim 5, wherein the catch defines a first detent and a second detent, wherein the primary pawl includes a main body and an primary arm extending therefrom, wherein a first side of the primary arm includes a locking wedge configured to be received by the first detent when the catch is in the use position and configured to be received by the second detent when the catch is in the non-use position, and
wherein the primary arm includes a second side opposing the first side, the second side defining a cam follower configured to be engaged by a cam profile defined by the secondary pawl.

7. A latch configured to selectively lock and unlock a cushion of a vehicle seat for use in a vehicle, the cushion configured to be disposed in a use position and a non-use position, the latch comprising:
a catch configured to be fixed to the cushion of the vehicle seat and rotate about a first axis between the use position and the non-use position;
a primary pawl configured to rotate about a second axis, different than the first axis, between a locked position, in which the primary pawl engages and fixes the catch in the use position and the non-use position, and an unlocked position to permit rotation of the catch and the cushion; and
a secondary pawl configured to rotate about a third axis, different than the second axis, between an engaged position, in which the secondary pawl and the catch sandwich the primary pawl, and a disengaged position to permit disengagement of the primary pawl from the catch.

8. The latch of claim 7, further comprising:
a transmission assembly operatively coupled to the secondary pawl and configured to transmit a force applied to the transmission assembly by a user from the transmission assembly to the secondary pawl to rotate the secondary pawl about the third axis.

9. The latch of claim 8, wherein the transmission assembly includes a cable configured to be operatively coupled to the secondary pawl.

10. The latch of claim 8, wherein the transmission assembly includes:
an activation lever configured to rotate about a fourth axis, and including a first end and a second end, the first end configured to receive a force applied by the user, and the second end defining a slot, wherein as the activation lever rotates about the fourth axis, a portion of the secondary pawl translates along the slot.

11. The latch of claim 10, wherein the fourth axis and the second axis are the same.

12. The latch of claim 11, wherein with respect to a vehicle floor of the vehicle, the third axis is disposed between the first axis and the second axis.

13. The vehicle latch of claim 7, wherein the catch includes a main body and an arm extending therefrom, a distal end portion of the arm defining an aperture configured to receive a fastener configured to attach the catch to the cushion.

14. The vehicle latch of claim 7, further comprising:
a locking wedge cap formed of a polymeric material, wherein the primary pawl includes a locking wedge and the locking wedge cap is disposed on the locking wedge, wherein the catch defines a first locking detent and a second locking detent and the first and second locking detents are each configured to receive the locking wedge cap so that the primary pawl engages and fixes the catch in the use position and the non-use position.

15. A latch configured to selectively lock and unlock a cushion of a vehicle seat disposed in a use position and a non-use position, the latch comprising:
a support structure including a sidewall and a peripheral edge portion, the sidewall defining a cushion fixation aperture,
a catch configured to be fixed to the cushion of the vehicle seat and rotationally connected to the sidewall of the housing, the catch configured to rotate with the cushion about a first axis between the use position and the non-use position;
a primary pawl rotationally connected to the sidewall and configured to rotate about a second axis, different than the first axis, between a locked position, in which the primary pawl engages and fixes the catch in the use position and the non-use position and an unlocked position in which the primary pawl is spaced apart from the catch;
a secondary pawl rotationally connected to the sidewall of the housing and configured to rotate about a third axis, different than the second axis, between an engaged position, in which the secondary pawl and the catch sandwich the primary pawl, and a disengaged position to permit disengagement of the primary pawl from the catch; and
an activation lever rotationally connected to the sidewall of the housing and configured to rotate about a fourth axis, the activation lever including a main body, a first arm, and a second arm, the first and second arms extending from the main body, the first arm operatively coupled to the secondary pawl, and the second arm extending beyond an edge of the sidewall, wherein as a force is applied to the second arm, the activation lever rotates about the fourth axis to rotate the secondary pawl from the engaged position to the disengaged position.

16. The latch of claim 15, wherein the catch is configured to rotate about the first axis in a first rotational direction from the use position to the non-use position, and the secondary pawl is configured to rotate in a second rotational direction when rotates from the unlocked position to the locked position, wherein the second rotational direction is opposite the first rotational direction.

17. The latch of claim 16, further comprising:
a primary spring configured to bias the primary pawl in the first rotational direction.

18. The latch of claim 17, further comprising:
a secondary spring configured to bias the secondary pawl in the first rotational direction.

19. The latch of claim 18, wherein in response to a force applied to the second arm of the activation lever, the activation lever is configured to rotate in the first rotational direction to rotate the secondary pawl in the second rotational direction.

20. The latch of claim 16, wherein the secondary pawl defines a cam surface and a coupling member, wherein the primary pawl defines a cam follower and a locking member, the locking member opposing at least a portion of the cam follower and configured to engage and fix the catch in use position and the non-use position,
wherein in response to a force applied to the second arm of the activation lever, the first arm of the activation lever is configured to rotate in the first rotational direction and the second arm of the activation lever engages the coupling member to rotate the secondary pawl in the second rotational direction so that the cam surface of the secondary pawl disengages from the cam follower of the primary pawl.
